(19) United States
(12) Patent Application Publication
(10) Pub. No.: US 2013/0232150 A1
(43) Pub. Date: Sep. 5, 2013

(54) METHODS AND APPARATUS FOR THE MANAGEMENT AND VIEWING OF CALENDAR DATA

(71) Applicant: RESEARCH IN MOTION LIMITED, Waterloo (CA)

(72) Inventors: MARC REDDY GINGRAS, MONTREAL (CA); FANG YANG, WATERLOO (CA); JACOU SARRAZIN, MONTREAL (QC)

(73) Assignee: Research in Motion Limited, Waterloo, ON (CA)

(21) Appl. No.: 13/866,285

(22) Filed: Apr. 19, 2013

Related U.S. Application Data
(63) Continuation of application No. PCT/CA2011/050654, filed on Oct. 17, 2011.
(60) Provisional application No. 61/405,402, filed on Oct. 21, 2010.

(51) Int. Cl. G06F 17/30

(52) U.S. Cl. CPC G06F 17/30598
USPC 707/740

(57) ABSTRACT

The present document describes systems, methods and apparatuses relating to managing and viewing calendar data. A server or a client device, may receive and/or classify calendar data associated with a user, and store the data in a database. Statistics data is generated as a function of classified calendar data. The client device may present personalized views of at least a portion of the statistics data, including statistical and/or analytical information. One or more search categories and a type of data presentation may be received as user input. The server or the client device may generate the statistics data as a function of the received analysis criteria. Calendar data for multiple users may be collected and centrally processed, for example, at the server.

### RELATED APPLICATION

The present patent application is a continuation of PCT International Application No. PCT/CA2011/050654 filed Oct. 17, 2011, which claims the benefit of U.S. Provisional Patent Application Ser. No. 61/405,402 filed Oct. 21, 2010, the entire contents of both of which are incorporated herein by reference.

### FIELD

The subject matter disclosed generally relates to the field of computer networking and methods of calendar sharing and time management.

### BACKGROUND

Conventional time and contact management tools may allow a user to synchronize a portable device with a home computer or home network system, whereby calendar and time information available on the portable device may be browsed and viewed on the home computer and vice-versa.

With conventional time management tools, the user may browse the calendar manually and/or use keywords when the user is looking for a certain event.

### BRIEF DESCRIPTION OF THE DRAWINGS

Some example embodiments will now be described in greater detail with reference to the accompanying diagrams, in which:

FIG. 1 is a diagram illustrating an example system which may include apparatuses according to some example embodiments, and in which the methods according to some aspects of the disclosure may be performed;

FIG. 2 is a flowchart of an example processor-implemented method of generating and transmitting statistics data according to some example embodiments;

FIG. 3 is a block diagram of an example apparatus which may generate and transmit statistics data in accordance with the method of FIG. 2;

FIG. 4 is a block diagram of another example apparatus which may receive and display statistics data in accordance with the method of FIG. 2;

FIG. 5 is a block diagram of another example apparatus in accordance with some example embodiments;

FIG. 6 illustrates an example of a matrix that may be used to store classified calendar data in a database according to some example embodiments;

FIG. 7 is a flowchart of another example processor-implemented method of generating and transmitting statistics data in accordance with some example embodiments;

FIG. 8 is a block diagram of an example apparatus which may generate and transmit statistics data in accordance with the method of FIG. 7;

FIG. 9 is an example of a display of statistics data in a “statistics page”, including multiple sections, in accordance with some example embodiments;

FIG. 10 is an example of a personal details section of the display of statistics data of FIG. 9;

FIG. 11 is an example of a graph section of the display of statistics data of FIG. 9, which displays the statistics based on the number and date of the meetings;

FIG. 12 illustrates an example of a date picker for selecting a start date and an end date to determine the date range for the statistics that are to be displayed in the display of statistics data of FIG. 9;

FIG. 13 illustrates an example of a statistics summary section of the display of statistics data of FIG. 9;

FIG. 14 illustrates an example of a participants section of the display of statistics data of FIG. 9;

FIG. 15 illustrates an example of a top locations section of the display of statistics data of FIG. 9;

FIGS. 16A to 16E illustrate further examples of a “statistics page” for presentation on a display;

FIG. 17 illustrates an example of a “daily digest” for presentation on a display in accordance with some example embodiments; and

FIG. 18 shows a block diagram of an example mobile device.

### DETAILED DESCRIPTION

In accordance with one aspect, there is provided a method implemented by a processor, comprising: generating statistics data as a function of classified calendar data, the classified calendar data comprising, for each of a plurality of calendar events, a respective plurality of data items that are collectively organized according to a plurality of event data categories; and transmitting at least a portion of the statistics data.

In some example embodiments, the classified calendar data is stored in a first matrix in a database.

In some example embodiments, the first matrix includes a row for each of the plurality of calendar events and a column for each of the plurality of event data categories such that each of the data items of the classified calendar data corresponds to a respective field of the first matrix.

In some example embodiments, the plurality of data categories includes at least one of: meeting type data; participant data; date data; duration data; and location data.

In some example embodiments, the method further includes receiving calendar data for at least one of the plurality of calendar events.

In some example embodiments, the method further includes transmitting a request for the calendar data for the at least one of the plurality of calendar events.

In some example embodiments, the method further includes classifying the calendar data, thus received, to generate at least a portion of the classified calendar data.

In some example embodiments, the method further includes receiving at least a portion of the classified calendar data.

In some example embodiments, generating the statistics data as a function of the classified calendar data includes correlating data items for at least one of the plurality of calendar events and data items corresponding to at least one of the plurality of event data categories.

In some example embodiments, generating statistics data as a function of classified calendar data includes generating statistics data as a function of data items of two or more of the plurality of data categories.

In some example embodiments, generating statistics data as a function of the classified calendar data includes generating statistics data as a function of the classified calendar data and at least one analysis criterion.

In some example embodiments, the at least one analysis criterion includes at least one common denominator.

In some example embodiments, the plurality of event data categories includes at least one of: meeting type data; participant data; date data; duration data; and location data, and the at least one common denominator includes at least one of: a meeting type; a participant; a date; a duration; and a location.

In some example embodiments: the classified calendar data is stored in a first matrix in a database; and generating statistics data as a function of the classified calendar data and at least one analysis criterion includes: generating a respective additional matrix containing classified data for each of the plurality of calendar events including the at least one common denominator in the respective plurality of data items of that calendar event.

In some example embodiments, the method further includes receiving the at least analysis criterion.

In some example embodiments, transmitting the at least a portion of the statistics data includes transmitting a message for reception by a client device, the message containing the at least a portion of the statistics data.

In some example embodiments, the method further includes, for each of at least one of the plurality of calendar events, receiving a respective event tag and storing the event tag as one of the respective plurality of data items of the calendar event.

In some example embodiments, the method further includes generating at least one data item of the respective plurality of data items for at least one calendar event.

In some example embodiments, the method further includes receiving for at least one of the plurality of calendar events, context data associated with one or more of the plurality of data items.

In accordance with another aspect, there is provided an apparatus including: a processor configured to: generate statistics data as a function of classified calendar data, the classified calendar data including, for each of a plurality of calendar events, a respective plurality of data items that are collectively organized according to a plurality of event data categories; and transmit at least a portion of the statistics data.

In some example embodiments, the apparatus further includes: the processor configured to: receive calendar data for at least one of the plurality of calendar events; and classify the received calendar data to generate at least a portion of the classified calendar data.

In some example embodiments, generating statistics data as a function of the classified calendar data includes generating statistics data as a function of the classified calendar data and at least one analysis criterion.

In some example embodiments, the apparatus further includes a database that stores at least one of the classified calendar data and the statistics data.

In some example embodiments, the apparatus further includes the processor configured to receive at least one of: the at least one analysis criterion; and for each of at least one of the plurality of calendar events, a respective event tag and for storage as one of the respective plurality of data items of the calendar event.

In accordance with another aspect, there is provided a method implemented by a processor including: receiving statistics data generated as a function of classified calendar, the classified calendar data including, for each of a plurality of calendar events, a respective plurality of data items, the data items collectively being organized according to a plurality of event data categories; and presenting the received statistics data on a display.

In accordance with another aspect, there is provided a method implemented by a processor comprising: generating statistics data as a function of classified calendar data, the classified calendar data comprising, for each of a plurality of calendar events, a respective plurality of data items that are collectively organized according to a plurality of event data categories; and presenting the received statistics data on a display.

In accordance with another aspect, there is provided an apparatus comprising: a processor configured to generate statistics data as a function of classified calendar data, the classified calendar data comprising, for each of a plurality of calendar events, a respective plurality of data items that are collectively organized according to a plurality of event data categories; and a display presenting the statistics data.

In accordance with another aspect, there is provided a method implemented by a processor, including: retrieving calendar data from a calendar; classifying data associated with each calendar event; storing the classified calendar data in a database in a first matrix; processing the classified calendar data and generating correlation information between different rows and columns of different calendar events; receiving a selection of at least one search category; presenting a personalized view of the calendar data, based on the selection.

In some example embodiments, the method further includes: receiving a selection of a time range for the calendar data to be presented.

In some example embodiments, the method further includes: assigning a tag to at least one calendar event in the calendar; and adding the tag to a list of search categories.

In some example embodiments, the method further comprises: assigning more than one tag to at least one calendar event in the calendar.

In some example embodiments, the method further includes: granting access to calendar events having a certain tag.

In some example embodiments, wherein generating correlation information includes creating at least one virtual matrix based on a common denominator of the data included in the first matrix.

In accordance with another aspect, there is provided a server including: a processor configured to retrieve calendar data from a calendar and classify data associated with each calendar event; a database configured to store the classified calendar data as a matrix; the processor configured to: process the classified calendar data and generate correlation information between different rows and columns of different calendar events; receive a selection of at least one search category; and generate and present personalized views of the calendar data, based on the selection.

Other aspects and features of the present disclosure will become apparent, to those ordinarily skilled in the art, upon review of the following description of some specific example embodiments.

Features and advantages the usefulness of the subject matter hereof will become more apparent in light of the following detailed description of selected example embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

Conventional time management tools do not provide statistics or analytics information that allows the user to manage their meetings and receive personalized statistics views of their calendar data. For example, conventional tools may not show data in aggregation from different events (e.g. all locations that a user has been with a specific person, or all the people a user has met at a given time).

Some aspects of the present disclosure relate to methods, apparatuses and systems for managing and viewing calendar data.

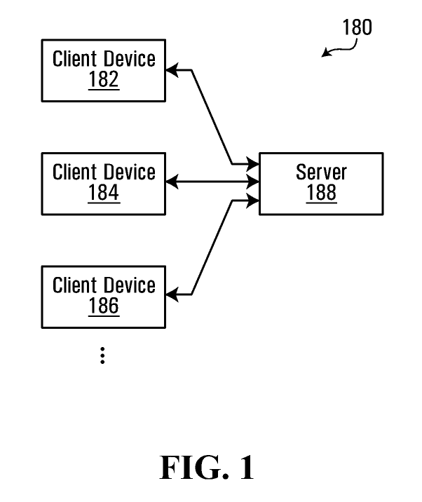

FIG. 1 is a diagram illustrating an example system 180 which may include apparatuses according to some example embodiments and in which the methods according to some aspects of the disclosure may be performed. FIG. 1 shows a plurality of client devices, including client devices 182, 184 and 186, and a server 188. The system 180 may include more or fewer client devices. Each of the client devices 182, 184 and 186 is in communication with the server 188. For example, communication with the server 188 may be through a local network or through the Internet. The server 188 may also be in communication with one or more other servers (not shown) or other network components (not shown).

An electronic calendaring application is run on the client devices 182, 184 and 186, on the server 188, or on both. The client devices 182, 184 and 186 and/or the server 188 may access and/or store calendar data associated with the calendaring application. For example, if the calendaring application is run by the server 188, then the server 188 may transmit/receive electronic calendar data to/from one or more of the client devices 182, 184 and 186. Electronic calendar information may be stored and processed at either the client devices 182, 184 and 186, or the server 188, or both. The server 188 may receive calendar information or other information from sources external to the system 100. For example, the server 188 may be connected to the Internet such that calendar information may be retrieved from LINKEDIN™, MICROSOFT OUTLOOK™, social networking website applications, etc.

The term “client device” includes, but is not limited to, personal computing devices, user terminals, and other similar computing devices. A client device may also be a mobile communication device. A mobile communication device may communicate with the server directly through a network. A mobile communication device may also communicate with a computing device (such as a desktop or laptop computer, for example) that, in turn, communicates with the server. For example, a mobile communication device may be “synchronized” with a computer. Synchronizing may include sending data, such as electronic calendar data, to the computer and/or receiving data from the computer, such that the mobile communication device and the computer have the same data.

In some example embodiments, there may be multiple servers in communication. For example, the server 188 may be in communication with servers hosting data and/or applications such as LINKEDIN™, BING NEWS™, etc.

Calendar data may include data for a plurality of calendar events. Calendar events are any scheduled occurrence, either future or past. Examples of calendar events include, for example, meetings, appointments, phone, video or internet conferences, etc. Each calendar event is defined by a number of data items. Each data item defines a characteristic of the respective event. For example, the data items defining a given calendar event may include the type of the meeting (e.g. physical meeting, online meeting, video conference, phone conference, lunch, coffee break etc.); an identification of the person(s)/participant(s) associated with the event; a duration of the event; date of the event; meeting notes; and a location of the event. Embodiments are not limited to these examples of data items.

The term “classified calendar data” used herein refers to calendar data in which data items are organized according to a plurality of event data categories. Accordingly, each data item in classified calendar data is a data item of one of the calendar events classified into one of the event data categories. A data item classified into an event data category is said to correspond to that event data category.

Event data categories define categories of event characteristics. In some example embodiments, event data categories include: meeting type data; participant(s) data; date data; duration data; and location data. Any other characteristics of a calendar event may also be used as an event data category. In some example embodiments, a user may define the event data categories to be included in the classified calendar data.

As mentioned above, each data item in classified calendar data is a data item of one of the calendar events classified into one of the event data categories. For example, if one event data category is meeting type data, then a corresponding data item for each calendar event defines the type of meeting for that event. For example, the corresponding data item for a first event may be “personal”, while the corresponding data item for a second event may be “business”. Other meeting types may include “external”, “internal”, “lunch”, “phone conference” etc. As another example, data items corresponding to the “participant” event data category may identify the specific participants expected to participate in the respective calendar events. As will be appreciated by one skilled in the art, the specific form and content of classified calendar data may vary, and example embodiments are not limited to any of the particular event data categories listed above. In some example embodiments, the event data categories under which the data items are organized may include categories of data not specifically identified herein.

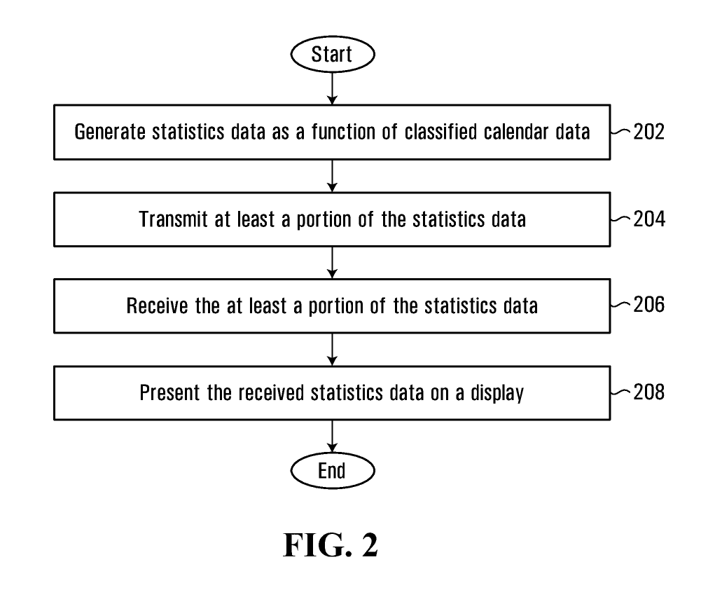

FIG. 2 is a flowchart of an example processor-implemented method of generating and presenting statistics data. At block 202, statistics data is generated as a function of classified calendar data. Statistics data is produced by an analysis and/or interpretation of the classified calendar data. Statistics data may include one or more quantities generated as a function of the classified data. For example, the one or more quantities may include a number, percentage, or list of events and/or data items meeting a certain criteria. Statistics data may further include the data items of all events meeting a certain criteria. Statistics data may describe a correlation (e.g. dependency or relationship) between one or more sets of the data items in the classified calendar data. For example, statistics data may include the frequency that events within a certain date range occur at a particular location. Various examples of statistics data that may be generated as a function of classified calendar data are discussed below. Example embodiments are not limited to any particular type of statistics data. The term “statistics data” as used herein may also include analytical information, as will be described below. The statistics data may be generated using a processor.

The statistics data may be generating statistics data as a function of data items at least two event data categories. This may allow multiple statistics data to be generated as a function of multiple data items for at least one event. For example, rather than simply generating a statistics quantity based on one event data category, a statistics quantity based on correlations between multiple event data categories may be generated (e.g. the percentage of meetings with a specific participant, occurring at a specific location). Thus, greater flexibility in the types of statistics generated as a function of classified calendar data may be provided.

At block 204, at least a portion of the statistics data is then transmitted. In some example embodiments, the statistics data is transmitted by a server (such as the server 188 shown in FIG. 1) for reception by a client device (such as any one of the client devices 182, 184 and 186 shown in FIG. 1). The data may also be transmitted by the server for reception by more than one client device.

At block 206, the at least a portion of the statistics data is received. The at least a portion of the statistics data may be received, for example, by a client device such as one of the client devices 182, 184 and 186 in FIG. 1.

At block 208, the at least a portion of the statistics data is presented on a display. In some example embodiments, the client device that received the at least a portion of the statistics data displays the received data for viewing by a user of the client device.

FIG. 2 shows blocks performed at both transmitter components and receiver components. However, in some example embodiments, only blocks performed by transmitter components (such as a server) are performed. In other example embodiments, only blocks performed by receiver components (such as a client device) are performed. Example embodiments are not limited to which particular system component generates the statistics data.

According to some example embodiments, an apparatus is provided that performs blocks 202 and 204 shown in FIG. 2. The apparatus in these example embodiments may not perform blocks 206 or 208. The apparatus may be a server such as the server 188 shown in FIG. 1.

According to some example embodiments, an apparatus is provided that performs blocks 206 and 208 shown in FIG. 2. The apparatus in these example embodiments may not perform blocks 202 or 204. The apparatus may be a client device such as any of the client devices 182, 184 and 188 shown in FIG. 1.

According to other example embodiments, an apparatus is provided that performs blocks 202 and 208 shown in FIG. 2. The apparatus in these example embodiments may not perform blocks 204 and 206. The apparatus may be a client device such as any of the client devices 182, 184 and 188 shown in FIG. 1.

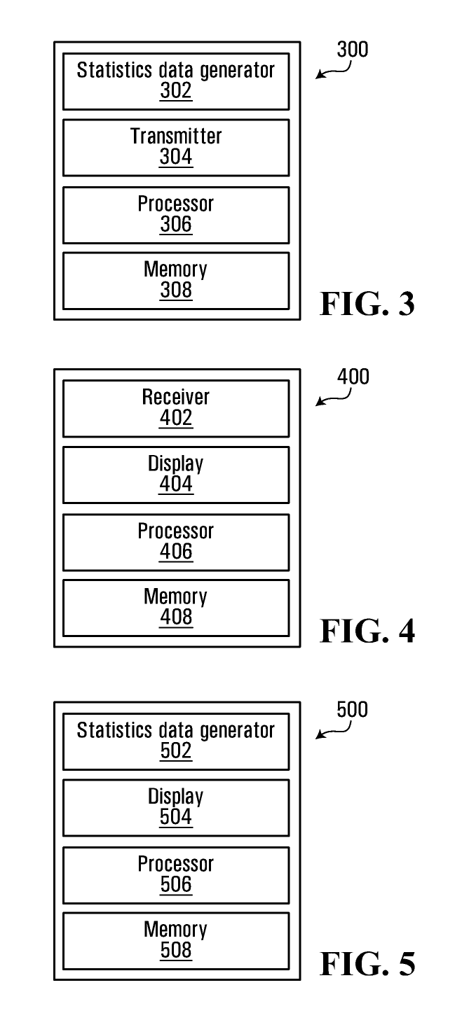

FIG. 3 is a block diagram of an example apparatus 300 which may generate and transmit statistics data in accordance with the method of FIG. 2. The apparatus 300 may be a server, such as the server 188 shown in FIG. 1. The apparatus 300 includes a statistics data generator 302, a transmitter 304, a processor 306 and a memory 308. The statistics data generator 302 generates statistics data as a function of classified calendar data. The transmitter 304 transmits at least a portion of the statistics data.

The statistics data generator 302 may be implemented as a processor configured to generate the statistics data. The statistics data generator 302 may be implemented as a memory (such as the memory 308) containing instructions for execution by a processor (such as the processor 306), by hardware, or by a combination of instructions stored in a memory and additional hardware, to name a few examples. The transmitter may be implemented as the processor configured to transmit the statistics data. In some example embodiments, the statistics data generator 302 and the transmitter 304 share components such as the processor 306 or the memory 308.

FIG. 4 is a block diagram of an example apparatus 400 which may receive and display statistics data in accordance with the method of FIG. 2. The apparatus 400 may be a client device, such as one of the client devices 182, 184 and 186 shown in FIG. 1. The apparatus 400 includes a receiver 402, a display 404, a processor 406 and a memory 408. The receiver 402 receives at least a portion of statistics data, which is generated as a function of classified calendar data. For example, the apparatus 400 may receive the at least a portion of the statistics data in a transmission from the apparatus 300 shown in FIG. 3. The display 404 is used to present the received statistics data. The receiver may utilize the processor 406 and/or the memory 408. For example, the receiver may include a processor configured to receive the statistics data.

FIG. 5 is a block diagram of another example client device 500 which may generate and display statistics data in accordance with some example embodiments. The apparatus 500 includes a statistics data generator 502, a display 504, a processor 506 and a memory 508. The statistics data generator 502 generates statistics data as a function of classified calendar data and is similar to the statistics data generator 302 of the apparatus 300 shown in FIG. 3. The display 504 is used to present at least a portion of the statistics data.

The statistics data generator 502 may be implemented as a processor configured to generate the statistics data. The statistics data generator 502 may be implemented as a memory (such as the memory 508) containing instructions for execution by a processor (such as the processor 508), by hardware, or by a combination of instructions stored in a memory and additional hardware, to name a few examples.

In some example embodiments, classified calendar data is stored in a database. The classified calendar data may be stored in the database in a first matrix.

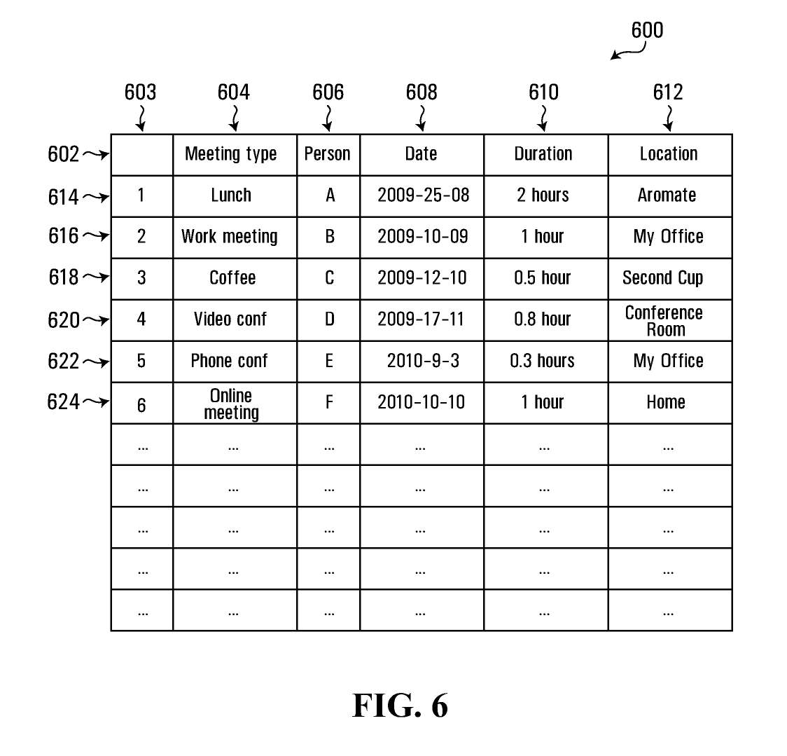

FIG. 6 illustrates an example of a matrix 600 of classified calendar data that may be stored in a database according to some example embodiments. In the example shown in FIG. 6, the first row 602 of the matrix includes a set of event data categories under which the information (data items) for the calendar events is classified. A first column 603, in this example matrix, includes a set of indices (1, 2, 3, 4, 5, 6 . . . ) designating each calendar event. In this example embodiment, there is a separate column 604, 606, 608, 610 and 612 of the matrix for each event data category. The event data categories for this example embodiment include “Meeting Type” (column 604), “Person” (column 606), “Date” (column 608), “Duration” (column 610), and “Location” (column 612) categories.

Example embodiments are not limited to the particular event data categories shown in FIG. 6. In other example embodiments, an event data category relating to the priority of different calendar events, costs associated with calendar events, etc. may also be used. One skilled in the art will appreciate that data stored for electronic calendars may be classified into various other event data categories not shown in FIG. 6 or specifically discussed herein. More or less event data categories (columns in the matrix 600) may also be used. In some example embodiments, the event data categories contained in the classified calendar data are customizable. For example, a user may designate what event data categories are set out in the classified calendar data. The total number of event data categories may also be customizable. As will be explained below, in some example embodiments a user can add or create an event data category in order to “tag” calendar events with a certain status.

The remaining rows of the example matrix 600 shown in FIG. 6, including rows designated by reference numbers 614, 616, 618, 620, 622 and 624, each contain data items for a different calendar event (1, 2, 4, 5, 6, . . . ). For each row, the data items are organized into the various event data categories 604, 606, 608, 610 and 612. The data items of the classified data stored in the matrix 600 are organized into rows and columns such that each of the data items of the classified calendar data corresponds to a respective field of the first matrix. As noted above, the matrix shown in FIG. 6 is only an example of how classified calendar data may be stored according to some example embodiments. In other example embodiments, data items in for more or fewer calendar events are present in the classified calendar data. In some example embodiments, the data items are classified according to more or fewer event data categories.

In some example embodiments, statistics data is generated as a function of at least one analysis criterion. An analysis criterion defines a type of statistics data to be generated. The at least one analysis criterion, in some example embodiments, includes at least one common denominator. For example, generating statistics data as a function of at least one common denominator may include grouping all calendar events having data item(s) that match the at least one common denominator. The at least one common denominator may be possible data items for one or more event data categories. For example, if the common denominators are a particular meeting type, a particular date and a particular person, then calendar events having the particular meeting type, date, and participant as data items may be designated as a subgroup of calendar events. Other subgroups of calendar events based on another common denominator, or another combination of common denominators, may also be created.

In some example embodiments, generating the statistics data as a function of the classified calendar data includes generating quantities such as percentages or numbers of calendar events or data items satisfying an analysis criterion. For example, an analysis criterion may be a set value or range of values such as date, time, duration etc. In this case, a number or percentage of calendar events fitting within the set date, time or duration (or within the set range) may be determined. As another example, an analysis criterion may be a particular participant, and the statistics data that is generated may be a number of times that a user is scheduled to meet that participant in a given date range. Another example quantity that may be generated includes the total number of different data items (e.g. different participants, locations, etc) classified under a given category. Further examples of statistics data include the number of calendar events scheduled over a certain time range, or the percentage of time spent in certain types of calendar events. In addition, statistics regarding the identity and number of participants may be generated. Other statistical quantities may be generated as a function of the classified calendar data.

At least one analysis criterion may be pre-set (for example, by a user) and may, thus, already be known to the apparatus performing the method. In some example embodiments, at least one analysis criterion is received rather than being pre-set. For example, an analysis criterion may be received as user input. For example, a user may enter a search parameter for generating statistics data. The search parameter may include one or more analysis criteria such as one or more common denominator. A combination of pre-set and received analysis criteria may also be used.

In some example embodiments, generating the statistics data as a function of the classified calendar data includes correlating data items for at least one of the plurality of calendar events (e.g. rows in the matrix) and data items corresponding to at least one of the plurality of event data categories (e.g. columns of the matrix). For example, classified calendar data may be analyzed to determine correlations between meeting type and meeting location, participant, etc. For example, statistic data may include a correlation between a date range, a set of data items under a “participant” category and data items added by a user as specific event “tags” under an additional category. In a more particular example, the correlating the information as described above may produce statistics data regarding all meetings that include a particular person as a participant and which have a particular tag. Examples of event tags are described below.

One skilled in the art will recognize that a wide variety of statistical and/or analytical data may be generated. Analytical data may include a comparison of statistics information with reference data, such as goals or with other statistics information. The analytical data may be based on, for example, certain trends, frequencies or other statistics/analytics information contained in the statistics data, as will be discussed more below. According to some example embodiments, the statistics data may be used to make recommendations or suggestions based on analytical data.

Calendar data, may be collected and/or classified for central processing. “Classifying” calendar data may include organizing data items of raw calendar data (referred to herein as “unclassified” calendar data) according to event data categories. For example, in some example embodiments, the apparatus (such as a server or client device) receives calendar data. If the received data is unclassified, the apparatus device may classify the data for storage as classified calendar data. In some example embodiments, the apparatus requests the calendar data that is subsequently received.

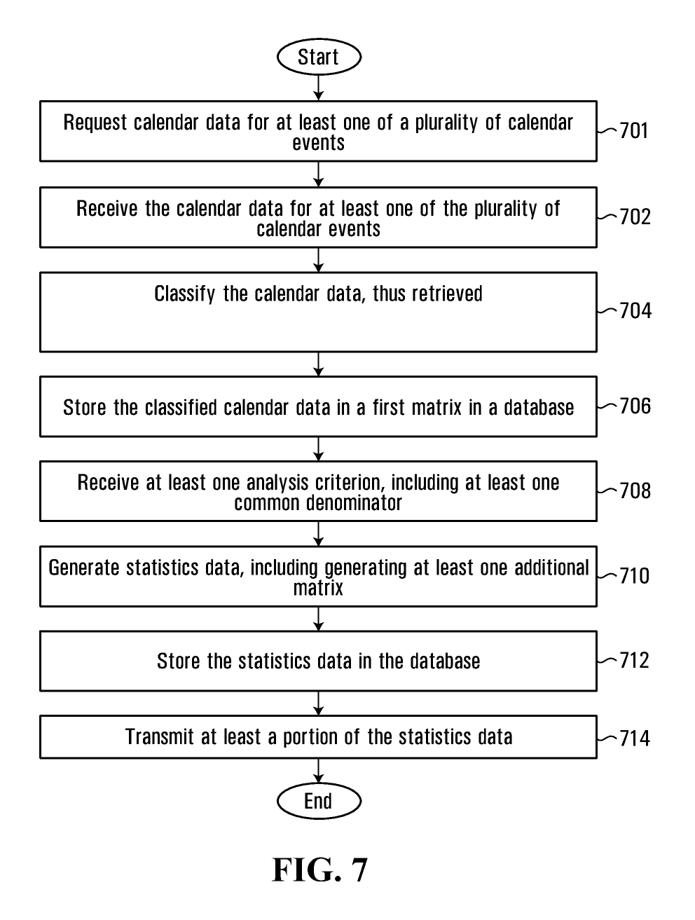

FIG. 7 is a flowchart of an example processor-implemented method that may be performed by an apparatus. For example, the method of FIG. 7 may be performed by an apparatus. The apparatus may be a server (such as the server 188 shown in FIG. 1) in accordance with some example embodiments. The method shown in FIG. 7 includes additional details concerning how the classified calendar data may be obtained and how statistics data may be generated in some example embodiments.

At block 701, a request for calendar data for at least one of a plurality of calendar events is transmitted by a transmitter. At block 702, calendar data corresponding to at least one of a plurality of calendar events is received with a receiver. In some example embodiments, the apparatus receives classified calendar data. In this example method, however, the apparatus receives unclassified electronic calendar data. The calendar data may be requested by the apparatus and received from one or more client devices and may be associated with one or more users' calendars, as will be explained in more detail below. In some example embodiments, the electronic calendar data is requested by the apparatus and received from one or more sources (e.g. through the Internet). Other sources may include one or more servers, Internet domains etc. For example, calendar data stored or hosted for applications, such as MICROSOFT OUTLOOK™, may be collected. Calendar data may be requested and/or received from any suitable source.

Calendar data associated with one or more users may be received. For example, an apparatus, such as the server 188 shown in FIG. 1, may receive and/or store calendar data associated with a plurality of users. In some example embodiments, the apparatus may receive the calendar data from multiple sources, such as multiple client devices and/or servers. The received calendar data may be classified and/or stored as aggregate classified calendar data. Example embodiments are not limited to any particular source or method of obtaining the calendar data.

Other example embodiments do not include receiving calendar data. In such example embodiments, the calendar data may have been previously stored at the apparatus. Thus, the apparatus would only need to access the stored data from memory rather than receive the data.

As noted above, in the example method shown in FIG. 7, the received calendar data is not yet classified calendar data. At block 704, the calendar data, thus received, is classified for storage as the classified calendar data. This classification may be performed using a processor. For example, the classifying the calendar data may include organizing the data into a format similar to the matrix shown in FIG. 6, although one skilled in the art will appreciate that other classification systems, including different event data categories, are possible. Classification may be done wholly automatically, or with assistance from a user. In some cases, classification may include deriving new data items based on the existing data items of the unclassified calendar data. For example, data items describing a type of participant or meeting may be derived from the contents of calendar data. This may include deriving information, for example, from an email address or other contact information. If a participant has a particular email address, the address may indicate that the meeting is “external”, or “internal”. As another example, based on the email address “personX@business123.com”, a data indicating a meeting as being with “business123”, or a particular meeting type based on “business123” may be derived.

In some example embodiments, classifying the received calendar data may include generating and/or deriving one or more data items for each calendar event. For example, the plurality of calendar events may include a combination of “active” and/or “historical”/“inactive” events. “Active” calendar events include events that are scheduled, but have not yet occurred and/or have not yet finished. “Inactive” or “historical” events include events that have concluded and are no longer “active”. However, the received calendar data may not include data items designating whether the calendar events are “active” or “inactive”. Appropriate date items for each event designating the event as “active” or “inactive” may be derived from the date on which the event is scheduled. Similarly, in some embodiments, data items defining whether calendar events are “internal” or “external” (for example, with respect to a company) are derived. As explained with reference to FIG. 14, this derivation may be performed as a function of the contact information of participants, for example. One skilled in the art will appreciate that various other scenarios where data items for classified calendar data are derived are possible.

At block 706, the classified calendar data is stored in a database in a first matrix.

At block 708, at least one analysis criterion is received with the receiver. In this example, the at least one received analysis criterion includes at least one common denominator. In some example embodiments, the at least one analysis criterion is received based on user input. In this example embodiment, the at least one analysis criterion includes a search parameter received from a user. The search parameter includes at least one common denominator. For example, the received search parameter may be a request for the durations of all meetings occurring at a selected location. In this case, the selected location would be a common denominator.

At blocks 710 and 712 in FIG. 7 statistics data is generated and stored. Each of blocks 710 and 712 are discussed in more detail below.

At block 710 the statistics data is generated. The statistics data may be generated using a processor. In this example embodiment, generating the statistics data includes, for each common denominator, generating at least one additional matrix containing the calendar events having data items that include the at least one common denominator. In some example embodiments, these one or more additional matrices are more temporary in nature than the first matrix storing all of the classified calendar data. Such temporary matrices are referred to herein as “virtual” matrices. However, example embodiments are not limited to additional matrices of statistics data being more temporary or “virtual”.

In the example where the received search parameter is a request for the durations of all meetings occurring at a selected location, the selected location may be used as a common denominator for generating a subgroup of events including the selected location as a data item classified in a “location data” category. Then, the total duration of meetings, in the subgroup, may be obtained by summing the values stored in data items classified in a “duration data” category in the subgroup.

As another example, common denominators may include selected meeting type(s), participant(s), date(s) etc. A subgroup of calendar events may be created to include all calendar events having “Lunch” classified under the event data category “Meeting Type”. Alternatively, meetings having common participants, dates, or any other common denominators may be grouped together. Subgroups based on combinations of common denominators may also be created. For example, a subgroup including all calendar events happening on a certain date with a certain person may be created.

The statistics data may include a respective virtual matrix for each common denominator (or for each combination of common denominators). For example, a given virtual matrix may include the classified calendar data of all meetings that happened in a certain place, with the same person etc.

As described above, various other types of statistical and analytical information may be generated and included in the statistics data. Statistics data may include derived data generated from the classified calendar data. The derived data may be derived in a similar manner as discussed above regarding deriving data items from received calendar data. For example, derived data may include a designation of calendar events as being “active”, “inactive”, “internal”, “external”, etc.

At block 712, the statistics data, thus generated, including the additional/virtual matrices, is stored in the database. In example embodiments where the apparatus generating the statistics data is a client device, rather than a server, the data may be stored at the client device.

The statistics data may be automatically generated based on at least one pre-set analysis criterion and stored/cached until such time that a request to transmit at least a portion of the statistics data is received. For example, a user may request data showing the frequency at which a particular location is visited with a particular person. Other pre-set analysis criteria may also be used such as the time range, the number of meetings, total duration of meetings etc. This information, together with other statistics data, may be automatically generated prior to the request with no need for input from the user. Then, when the request for that particular data is received, that particular data may be retrieved from storage and transmitted for reception by the user's client device. In other example embodiments, the statistics data, or at least a portion of it, is generated “on the fly”. For example, in some example embodiments, at least a portion of the statistics data is generated upon receipt of the request rather than being automatically generated ahead of time.

At block 714, the at least a portion of the statistics data is transmitted by the transmitter. The at least a portion of the statistics data may be transmitted, for example, for reception by one or more client device (such as one or more of the client devices 182, 184 and 186 shown in FIG. 1).

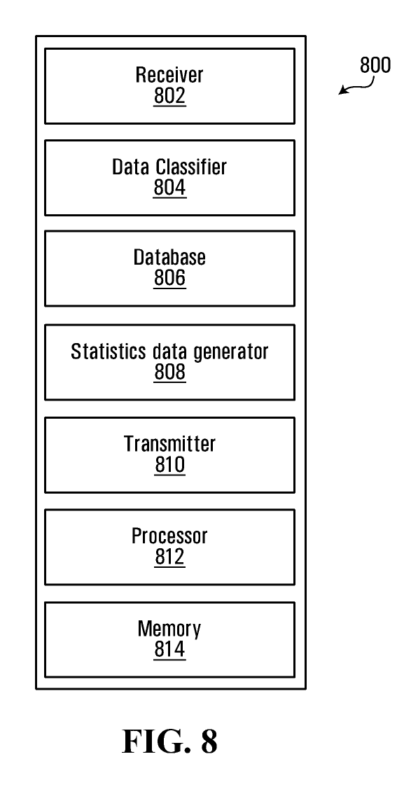

FIG. 8 is a block diagram of an apparatus 800, according to some example embodiments, that performs the method in accordance with FIG. 7. The apparatus 800 may be a server, such as the server 188 shown in FIG. 1. The apparatus 800 includes a receiver 802, a data classifier 804, a database 806, a statistics data generator 808, a transmitter 810 a processor 812 and a memory 814. The receiver 802 receives unclassified and/or classified calendar data. The receiver further receives at least one analysis criterion. The data classifier 804 classifies any received calendar data that is unclassified, as described above. The database 806 stores the classified calendar data and statistics data. For example, the database 806 may store the classified data in a first matrix in the form of the matrix 600 shown in FIG. 6. In some example embodiments, the database may only store one or the other of the classified calendar data and the statistics data. One or more additional databases may also be utilized for the storage of data. The database 806 may further store at least one pre-set analysis criterion. The statistics data generator 808 generates the statistics data as a function of the classified calendar data and the at least one analysis criterion, as discussed above. In some example embodiments, this includes correlating at least one row and at least one column of the first matrix as a function of the stored and/or preset analysis criteria. The database 806 stores the statistics data, thus generated.

The transmitter 810 transmits at least a portion of the statistics data (for example, for receipt by a client device). The transmitter 810 further transmits a request for unclassified and/or classified calendar data. For example, the request may be transmitted for reception by one or more client devices in communication with the apparatus. In some example embodiments the request is transmitted for reception by one or more sources (such as other servers) storing or hosting electronic calendar data.

The data classifier 804, the database 806 and the statistics data generator 808 may be implemented as a memory (such as the memory 814) containing instructions for execution by a processor (such as the processor 812), by hardware, or by a combination of instructions stored in a memory and additional hardware, to name a few examples. The data classifier 804 may be implemented as a processor configured to classify calendar data. The statistics data generator 808 may be implemented as a processor configured to generate the statistics data. The receiver 802 and the transmitter 810 may each be implemented as the processor configured to perform the respective receiving or transmitting functions discussed above. In some example embodiments, the receiver 802, the data classifier 804, the database 806, the statistics data generator 808 and the transmitter 810 share components such as the processor 812 or the memory 814.

According to some example embodiments, an apparatus, such as one of the client devices 182, 184 and 186 shown in FIG. 1, includes a receiver, a transmitter, data classifier, database, and/or statistics data generator similar to those of the server 800 shown in FIG. 8 and described above. The apparatus further includes a display similar to the display 404 shown in FIG. 4.

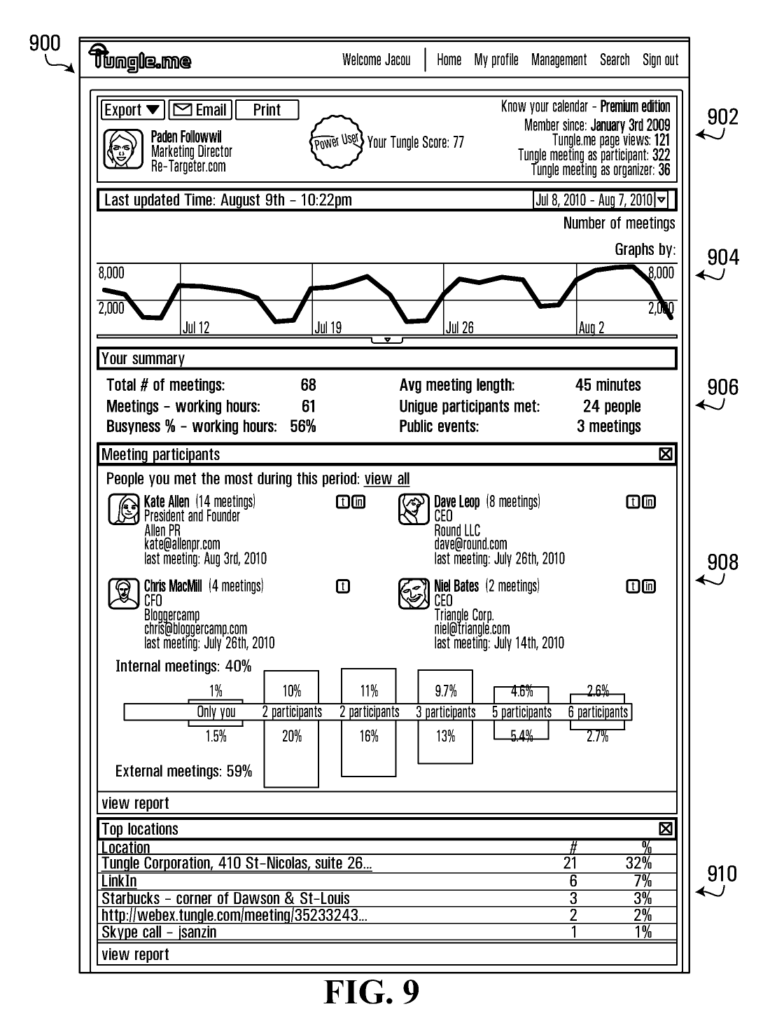

The statistics data may allow personalized views of the calendar data and statistical/analytical information to be generated from the calendar data to be presented to a user. The presentation of the statistics data (including the form and content of what is presented) may be customizable by the user. Several examples of how statistics data may be presented to a user are discussed below and shown in FIGS. 9 to 17. Each of FIGS. 9 to 17 shows an example graphical user interface that is presented in some example embodiments, although some displays may not include user interface elements. Included in the example GUIs of FIGS. 9 to 17 are several examples of the types of statistics data, including statistics and analytics, that may be generated from the classified calendar data. As will be apparent to one skilled in the art, methods for presenting statistics data on a display, and the types of statistical or analytical information contained in the statistics data, are not limited to the specific examples shown in FIGS. 9 to 17. The statistics data may be presented to the user in any number of customizable ways.

Once the classified calendar data is processed in order to generate the statistics data, at least a portion of the statistics data may be either received and/or stored by a client device (such as any of the client devices 182, 184 and 186 shown in FIG. 1), the display of the client device may present the at least a portion of the data in accordance with the user's choice. Presentation of the statistics data, both form and content, may be personalized by the user. With regard to the form, the user may choose to have the statistics data provided in the form of a chart, linear representation, visual representation, diagram, map, plan, outline, plot, rough draft, scheme, sketch, table, tabulation or any other format. The user may also personalize the content of the statistics data presented by selecting one or more search categories. The statistics data may include statistics or analytics information.

For instance, the user may choose to view in a graph, the number of meetings he/she had with a specific person in a specific restaurant, and within a specific time range. Upon receipt of the user's selection, the statistics data generator may perform a search of the database using the statistics data, and present the search results to the user in a graph. In some example embodiments, the presentation of the statistics data is in the form of a “statistics page” that is displayed for viewing by the user.

FIG. 9 is an example of a statistics page 900 presented to the user of an apparatus, such as a client device, including multiple sections, in an example embodiment. The example shown in FIG. 9 includes several sections including different type of statistics generated as statistics data. In particular, in this example, the statistics page 900 includes a personal details section 902, a graph section 904, a statistics summary section 906, a participants section 908, and a meeting locations section 910. One or more of the sections 902, 904, 906, 908 and 910 may be dropped down to view the information presented therein. The user may personalize the statistics page to select the sections that they want displayed therein, and the type of graphs that they want displayed. More sections or less sections than are shown in the example statistics page of FIG. 9 may be included. For example, the statistics page may only include the participants section 908. Alternatively, in some example embodiments, additional sections not shown in FIG. 9 are included that present additional statistical/analytical information contained in the statistics data.

As can be seen in FIG. 9, the data presented on a display is not limited to statistics data that is dependent on a specific date range. The statistics data shown may not be date range specific. Furthermore, data may be displayed, that is not part of the statistics data, may be presented together with the at least a portion of the statistics data.

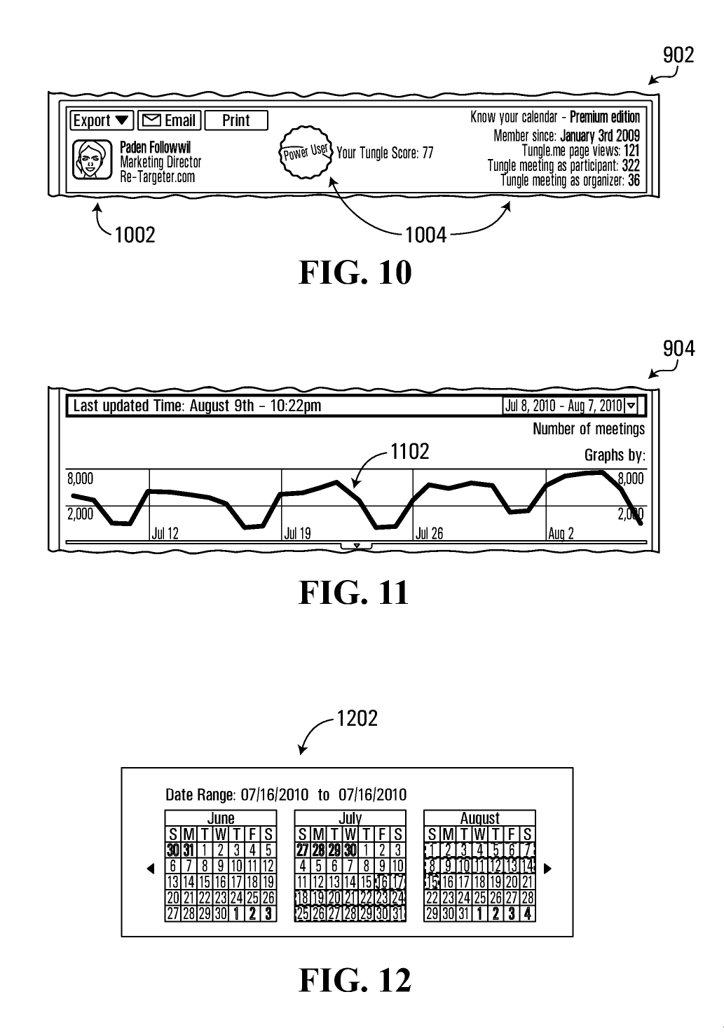

FIG. 10 is an example of the personal details section 902 shown in FIG. 9. This section includes information 1002 about the user, along with the account statistics 1004 such as the type of membership, number of meetings, etc. In an example embodiment, the personal details section may include a score which indicates the overall activity of the user on the website implementing an example embodiment.

FIG. 11 is an example of the graph section 904 of FIG. 900. The graph section 904 displays the statistics based on the number and date of the meetings. In this example, the statistics are presented in the form of a line graph 1102. The user may select the time range by selecting a start date and an end date. Either of the start and end date may be in the past to view historical statistics, and may also be in the future to manage future meetings and calendar events. Items of the graph may be mouse-overable. In other words, by mousing over a certain item or unit of the graph certain information will be displayed to the user. Examples of such mousing over activities are shown in the following table:

TABLE 1
Graph Dropdown

| | |
|---|---|
| Number of meetings | Mousing over each day displays a count of meetings for |
| | this day and lists all meeting subject. |
| Number of people met | Mousing over each day will display the number of people |
| | a user met during this day and their name/email. |
| Number of new people met | Mousing over each day will display the number of new |
| | people a user met - possibly only the first time a person |
| | is met is displayed (i.e. if a user met 10 times during the |
| | period, only the time is displayed) - possibly also display |
| | name and/or email. |
| Number of unique locations | Mousing over each day will display a number of new |
| | locations - possibly only the time location is used is |
| | shown - location names may be listed. |
| Number of hours in meetings | Mousing over each day will show the number of hours |
| | spent during meetings during this day (free, busy, |
| | tentative all included) - show list of meetings. |
| % of available times vs busy | Mousing over each day will show the percentage of the |
| | time a user was available vs busy, possibly based on a |
| | template. The template may be used at a calculation |
| | time. |
| Number of meetings with at | Mousing over each day displays a count and name of |
| least one external participant | the meetings that had at least one “email address” |
| | external. |
| Number of meetings with only | Mousing over each day displays a count and name of |
| internal participants | the meetings that have only “internal” participants based |
| | on email address. |

FIG. 12 illustrates an example of a date picker graphical interface 1202 that may be presented on a display of the client device in order for the user to select a start date and an end date to determine the date range for the statistics that are to be displayed.

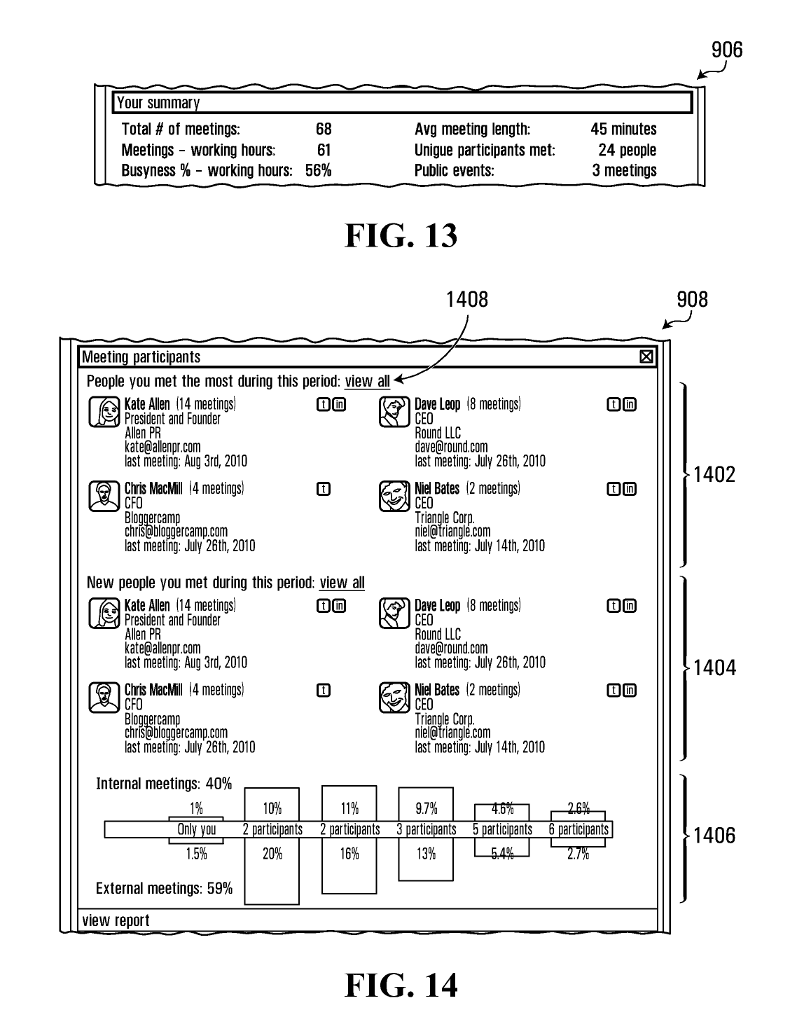

FIG. 13 illustrates an example of the statistics summary section 906 shown in FIG. 9. Examples of items that may be presented in this summary are shown in table 2 below.

TABLE 2
Your Summary

| | |
|---|---|
| Total # of meetings | Number of meetings (all types) during the period. This |
| | includes free, tentative, and busy. |
| Meetings during working hour | Number of meetings (all types) during working hours (for |
| | now M-F, 8:30am to 5:30pm). This may be user |
| | configurable. |
| Busyness % - working hours | Percentage of time busy during working hours (defined |
| | above) - Busy event only (not tentative and free) |
| Mean of meeting length | Calculate the mean of all meetings during the period. All |
| | day, free, busy, tentatives are all included in the |
| | calculation. |
| Unique participant met | Total number of unique participants met during the |
| | period. |
| New people met during time | Only list new contacts that were met during this period |
| frame | and not before. |
| Attended public event | Total numbers of calendar events that are marked as |
| | public event during this period. |
| Total number of locations | List unique number of different locations. |

FIG. 14 illustrates an example of the participants section 908 shown in FIG. 9. In an example embodiment, the participants section may include three sub-sections designated by reference numbers 1402, 1404 and 1406 respectively in FIG. 14. In some example embodiments, a first subsection 1402 includes a list of people met during the specified date range. In some example embodiments, the people met the most are listed first. The number of people displayed may be restricted to a certain number (e.g. four people as shown in FIG. 14). In this example, a “view all” button 1408 is provided that, when activated, displays all of the participants. Other methods of displaying some or all of the participants meeting certain parameters may also be implemented.

In the example embodiment shown in FIG. 14, a second sub-section 1404 of the participants section 908 may present only the new people met during the specified date range. A third sub-section 1406 of the participants section displays a graph that shows the percentage of meetings in accordance with a criterion selected by the user. In the graph shown in FIG. 14, a comparison is shown between internal and external meetings. In some example embodiments, the internal v. external criterion is determined based on the email domain address. If the domain is the same, the meeting is considered internal, if domain is different, it is considered external. It is possible to provide a list of “excluded domains” such as gmail.com, hotmail.com, yahoo.com, etc. If a participant has an excluded domain, than the meeting is considered external. If the owner has an excluded domain, then all meetings are external. In an example embodiment, the user and/or administrator will be able to manually add wild cards or specific email addresses to indicate who is internal to an organization. For example, by default every address that has a domain @Tungle.com is considered internal to the Tungle organization. The user may also specify specific email addresses as being internal or external.

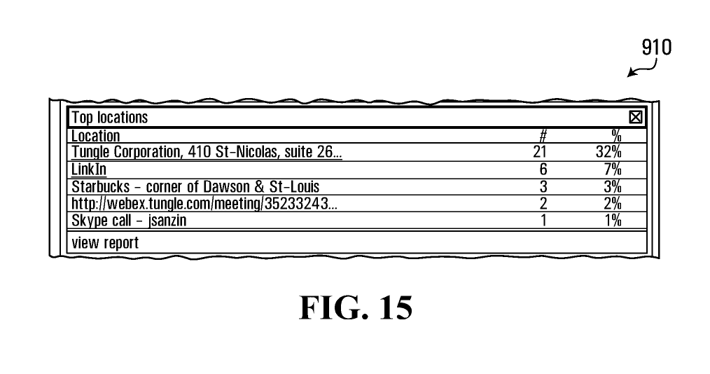

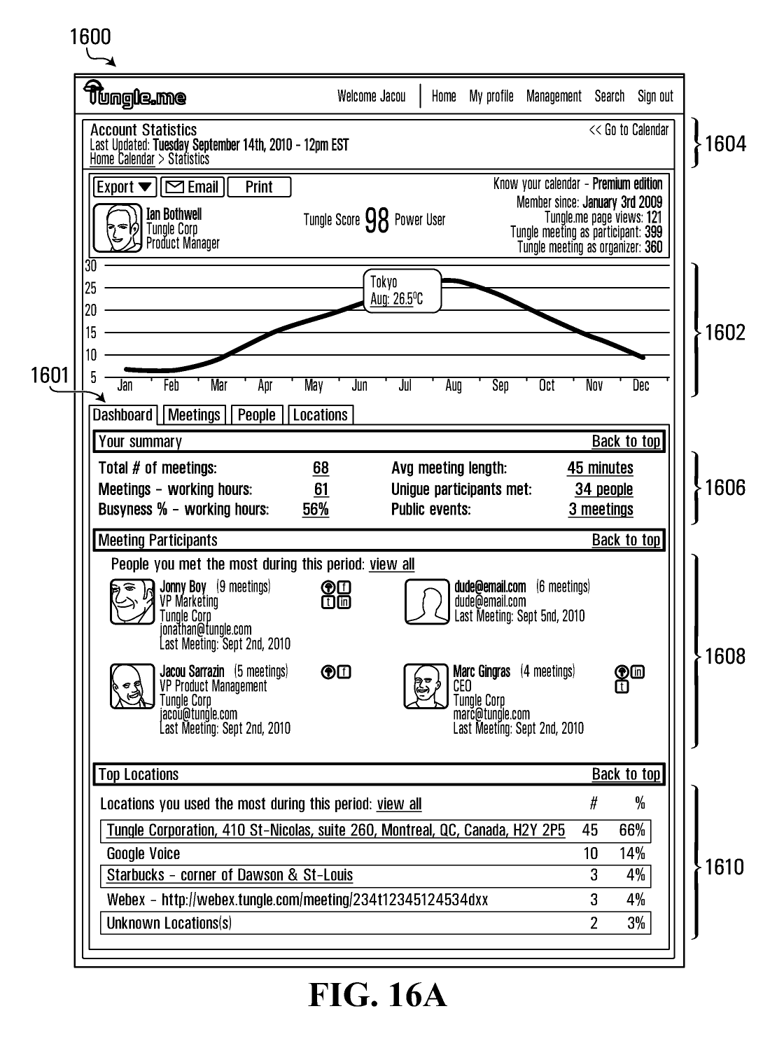

FIG. 15 illustrates an example of the top locations section 910 of FIG. 9. This section shows the locations that are visited starting by the ones which are used/visited the most. Although the section 910 is called top location, in some example embodiments it also displays non-physical means used for the calendar events such as websites, phone, etc. In some example embodiments, the number of times the location is used/visited and/or percentage are also displayed in this section, as exemplified in FIG. 15.

As stated above in connection with FIG. 9, the statistics page may be personalized by the user. In some example embodiments, the statistics page includes different tabs: dashboard, meetings, people, locations etc.

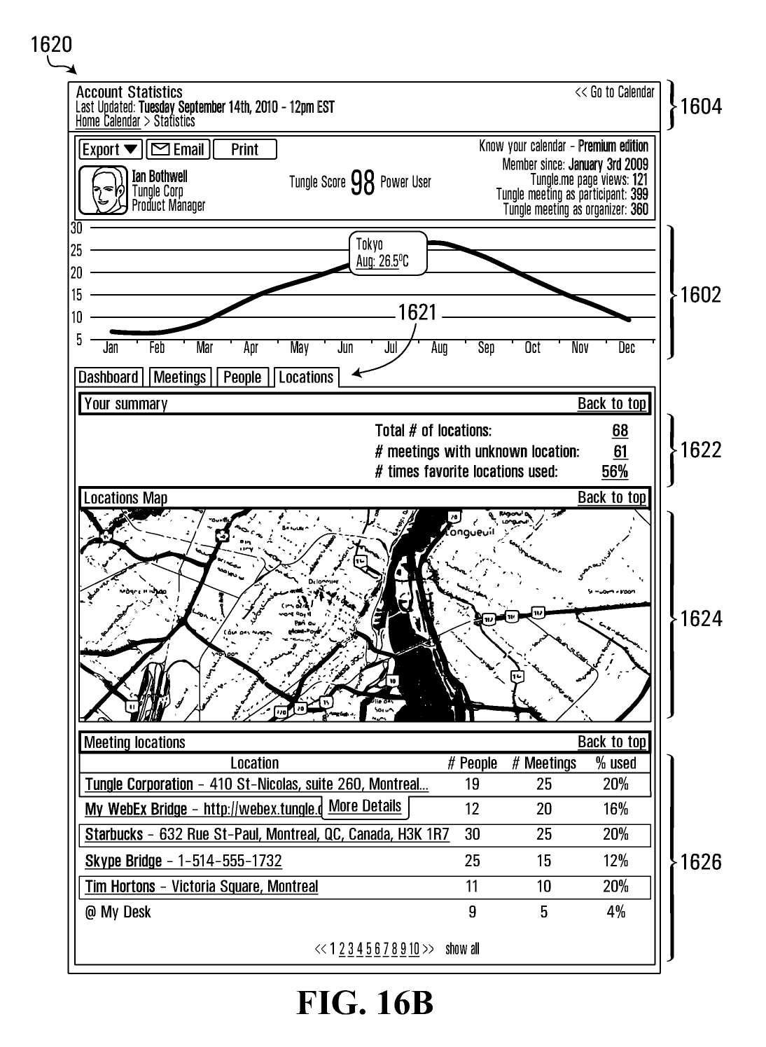

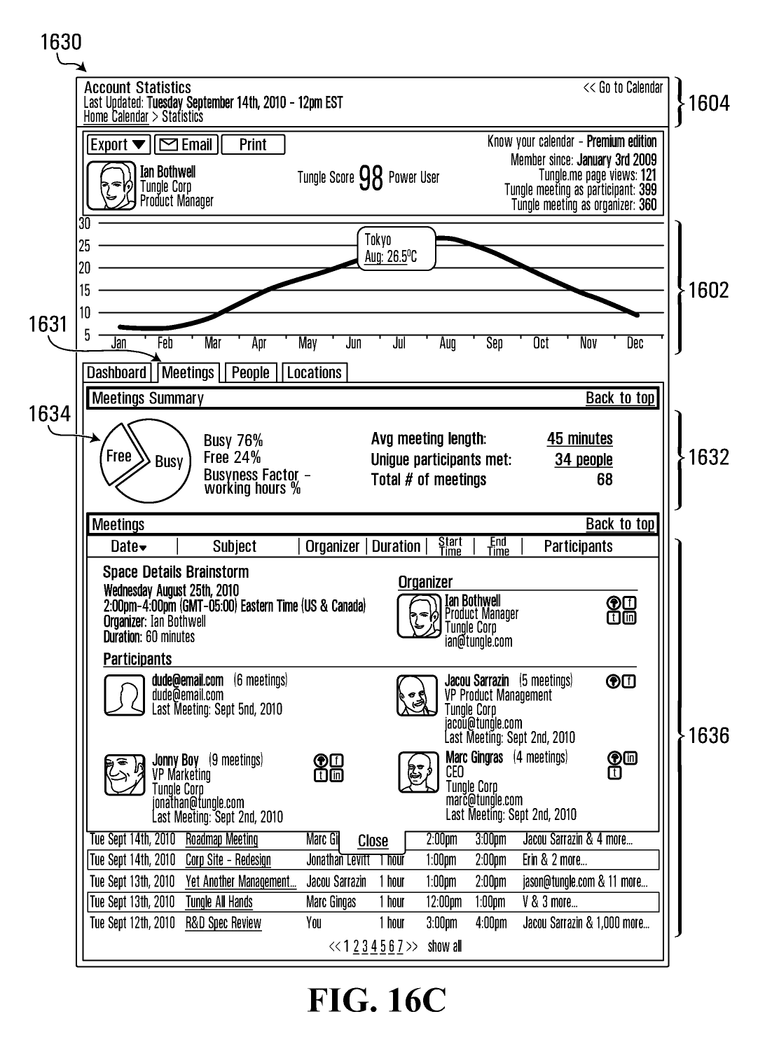

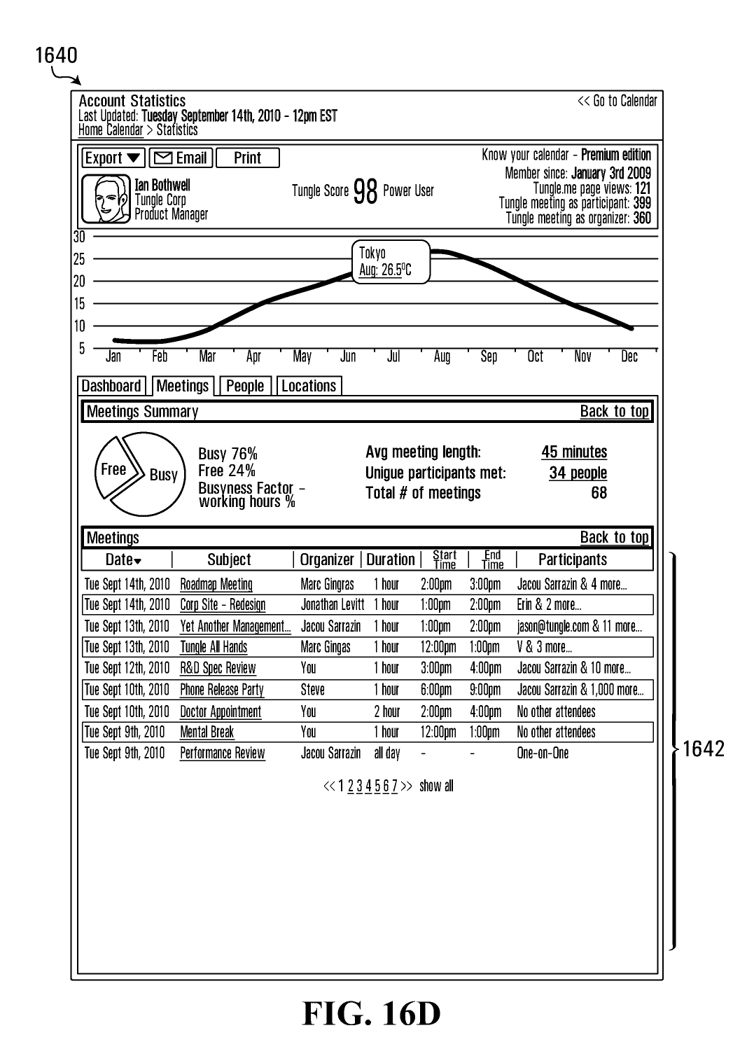

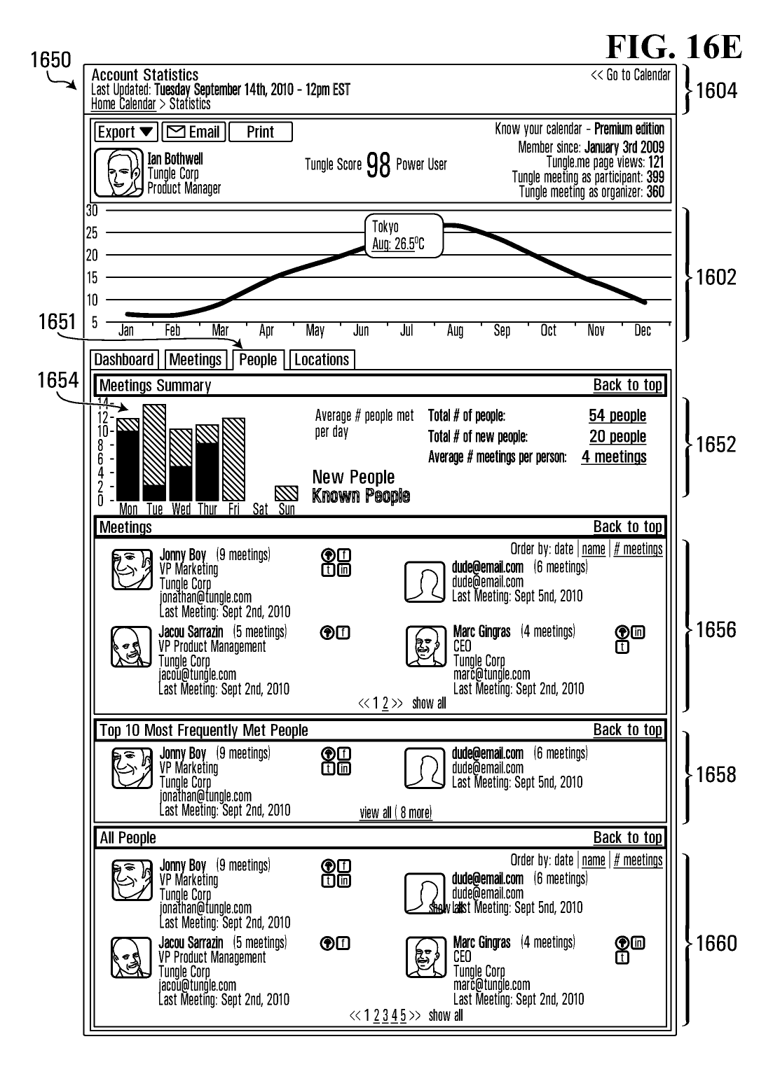

FIG. 16A shows an example of a statistics page 1600 under a dashboard tab 1601 according to some example embodiments. The sections included in this page 1600 include a graph 1602 showing the overall business of the user over a period of a year. The other sections include, the account statistics 1604 section, the summary section 1606, the meeting participants section 1608, and the top locations section 1610.

FIG. 16B shows an example of a statistics page 1620 under a locations tab 1621. The sections included in this page include the account statistics section 1604 and the graph 1602 shown in FIG. 16A, with a summary section 1622 about the locations, a map section 1624 which shows the locations on the map, and a meeting locations section 1626 which identifies the locations. The identification of the locations may include the address and/or name of the place or website etc. if this information is included in the calendar of the user.

FIG. 16C shows an example of a statistics page 1630 under a meetings tab 1631. The sections included in this page include the account statistics section 1604 and the graph 1602 shown in FIG. 16A, with a summary section 1632 about the meetings. The summary section 1632 in this example includes a graph 1634 representing the percentage of time during which the user was/is busy versus fee along with other details about the average meeting length, unique participants met, total number of meetings etc. The page 1630 also includes a meetings section 1636 including detailed information about the meetings. The meeting section 1636 may include a list of meetings that occurred within a specified date range. The list may include the start and end time of the meeting, the duration of the meeting, the organizer of the meeting, the participants, and the type or title of the meeting. The meeting section 1636 may also include a list of the participants that have been met the most along with an identification of the organizer that organized most meetings.

As stated above, the user may personalize the statistics page presented by eliminating and/or adding and/or modifying sections and subsections of the statistics page. For example, FIG. 16D shows a modified version of the statistics page 1600 shown in FIG. 16C without the information about the participants that are met the most in a modified meetings section 1642. The modified statistics page shown in FIG. 16D is designated with reference character 1640.

FIG. 16E is an example of a statistics page 1650 under a people tab 1651. The sections included in this page 1650 include the account statistics section 1604 and the graph 1602 shown in FIG. 16A, and a summary section 1652. The summary section 1652 in this example includes a graph 1654 comparing the number of new people versus known people for a specific day or month or any other date range, and an indication of the total number of people, total number of new people and the average number of meetings per person. The page 1650 also includes a list 1656 of people being met during a date range. The list 1656 identifies, for each participant, the name, title, company, emails, and date of the last meeting. The page 1650 also includes a list 1658 of the most frequently met people, and a list 1660 of all people. A further list may be included that shows only people being met for the first time.

As will be appreciated from the discussion above, various ways of personalizing the content and form of displayed statistics data, including statistical and analytical information, may be implemented. Example embodiments are not limited to any particular presentation shown in the example embodiments of the figures.

Calendar Event Tagging

As discussed above, in some example embodiments, an apparatus such as any of the apparatuses 300, 400, 500 and 800 described with respect to FIGS. 3, 4, 5, and 8, receives/collects calendar data of a certain user, classifies the information included in the calendar and stores the information in a database in the form of a matrix. In some example embodiments, the apparatus collects calendar data from multiple sources/databases for storing as aggregate classified calendar data and for processing the aggregate classified calendar data centrally. Thus, the statistics data generator may generate statistics data as a function of the aggregate classified calendar data.

In some example embodiments, calendar data from multiple sources may be synchronized, either by the apparatus. For example, calendar data from any of the following sources may be synchronized: GOOGLE TOOLBAR™; OUTLOOK™; EXCHANGE™; DOMINO™; LOTUS™; NOTES™; iCAL™; ENTOURAGE™; WINDOWS LIVE™; YAHOO!™; CALENDAR™; FACEBOOK CALENDAR EVENTS™; and TRIPIT™. One skilled in the art will appreciate that calendar data that is synchronized may also be from other sources not identified herein.

In some example embodiments, the methods described herein further include receiving a user-designated tag and assigning the tag to each calendar event in the user's calendar. In some example embodiments, the receiver and the data classifier may perform this event tagging function. An event may have more than one tag. For example, a certain client meeting may be tagged “work” and may also be tagged “out of the office meeting”. The methods and apparatuses described herein may use the personalized tags to allow the sharing of calendar events with a specific tag with multiple users. Thus, in some example embodiments, a portion of a particular user's calendar, rather than the entire calendar, may be shared. For example, the user may tag certain work related calendar events under “work”, family related calendar events under “family”, and personal calendar events under “personal”. This way, the user may share calendar events tagged under “family” with family members. In some example embodiments, the family members can only have access to calendar events that the user gave them access to, which in this case, are the ones that are tagged “family”. Family members cannot have access to calendar events tagged under “work” and “personal”. These calendar events are shown as blocks of time with a busy status. Another example tag is a tag describing the subject of a meeting such as “product”, “finance” etc.

In the method according to some example embodiments, a tag is received for at least one of the plurality of calendar events and stored as part of the classified calendar data. The tag may be stored as a classified calendar data item under a column in the matrix. For example, the matrix 600 shown in FIG. 6 may have an additional column added under which tags identifying a feature of each event are organized.

Personalized tagging may allow for a better management and viewing of past and future calendar events. For example, by categorizing the calendar events using different tags, users may view personalized statistics that help them evaluate their past activities and meet their future targets. For example, if the user wants to investigate the reason of a success or failure in meeting certain goals or tasks, they may obtain statistics showing the total number of hours spent on certain activities, to determine areas of strength and/or areas for improvement.

Target Setting

In some example embodiments, the method or apparatuses described herein allow the user to set targets and track their progress with respect to the targets set. For example, using a GUI, the user may enter a target number of new clients to meet within a certain time period. An apparatus such as any of the apparatuses 300, 400, 500 and 800 described with respect to FIGS. 3, 4, 5, and 8, may help the user achieve their target by sending reminders and/or progress reports showing one or more of: the number achieved up to date, the remaining number needed to achieve the target, a graph and/or a number showing the percentage of progress etc. The data presented in such reminders and/or progress reports may be generated by the statistics data generator.

In some example embodiments, targets may be related to one or more of the tags. For example, if the user's target is to spend a certain number of hours doing marketing activities in a certain month, they may enter the number of hours in the “Marketing” tab, and the statistics data generator may keep track of the new hours added to “marketing” tab and generate reminders and progress reports to help the user keep track of their progress and achieve their goal.

Management Statistics/Analytics

In accordance with some example embodiments, statistics and analytics of employees/team members may be managed collectively. For example, it is possible to share and have access to calendar events having the same tag with supervisors, and co-workers.

In accordance with some example embodiments, the user may access and share other user's targets. As an example, a team leader may set targets for his employees and receive reports on their progress and/or advancement with regard to the target set.

Comparative Analytics

In accordance with some example embodiments, the user may compare their statistics with other users. For example, a server or client device implementing the methods described herein may suggest users having similar profiles for comparison. In some example embodiments, some users may enable/disable this feature if they do not want to share their target information and/or their profile with other users.

Daily Digest

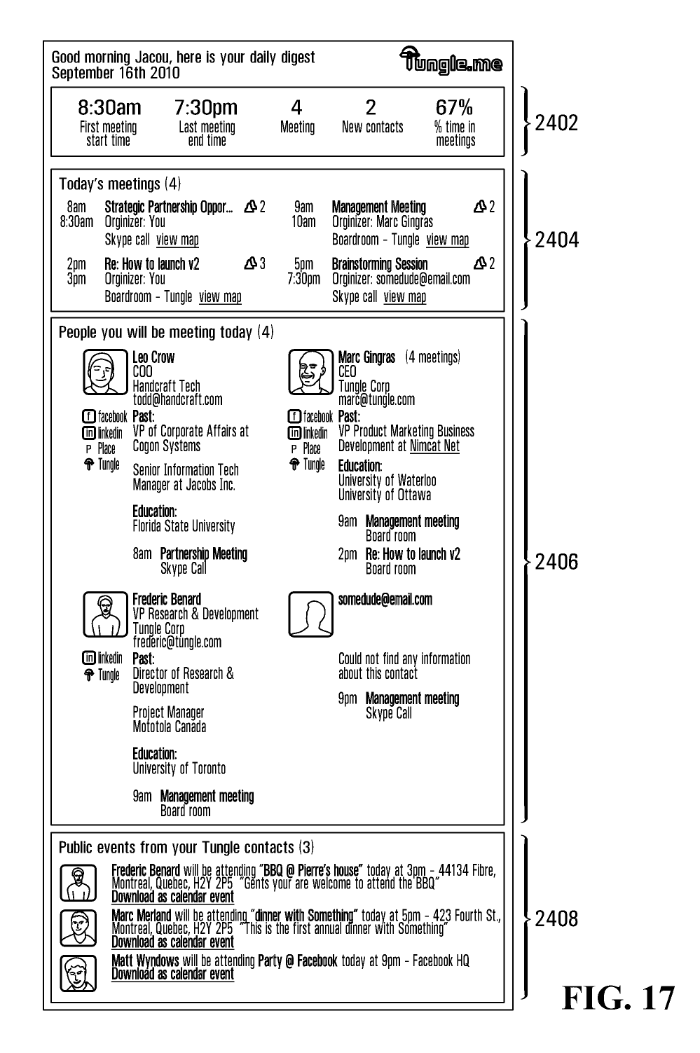

The method and apparatuses described herein may help a user prepare for the upcoming day/week/month. FIG. 17 shows an example briefing, which may be referred to as a “daily digest”, that may be displayed based on statistics data in accordance with some example embodiments. In some example embodiments, data from the user's calendar is used to send/display a daily digest (aka briefing) of the upcoming schedule for a particular date (or possibly for a range of dates). The briefing may be sent from a server to a client device in an email, Short Message Service (SMS). The briefing may also be provided to the client device and displayed on the client device as an alert or a web page etc. In some example embodiments, the client device creates the briefing for display to the user rather than receiving the briefing information from the server. The briefing may include, for example, the number of meetings, beginning and end of each meeting, meeting participants, location of the meeting, duration of the meeting etc.

The example daily digest shown in FIG. 17 includes sections indicated by reference characters 2402, 2404, 2406 and 2408. Section 2402 includes statistical information regarding calendar events scheduled on a particular date. In particular, section 2402 includes the first meeting start time and the last meeting end time, the number of meetings, the number of new contacts and the percentage of time that is spent in meetings. The percentage of time spent in meetings may be calculated based on a user defined available time throughout the day. Section 2404 includes an overview of the day's meetings including start and end times, meeting type or subject line, the number of participants (indicated by a number next to a generic participant icon), meeting organizer and meeting location. If the meeting organizer is the user for whom the data is presented, the organizer field may show “You” instead of the user's full name. If a meeting is scheduled to take all of the user's available time that day, the meeting times can simply show “All Day” or another phrase instead of start and stop times. Section 2406 includes information on the meeting participants that the user is scheduled to meet that day. In particular, profile photos, personal details (name, title, etc.), contact information, and meeting details for each participant are provided. Links to profile information on one or more sites or online servers may be provided (e.g. social networks, etc.). Section 2408 includes a list of events associated with the participants that are tagged as “public”, and can thus be viewed by people other than the respective participant, including the user. One skilled in the art will appreciate that these are specific examples of possible correlated participant data, and the content and form of correlated participant data presented on a display may vary.

Some information shown in the display may include a hyperlink to further information. For example, in FIG. 17, hyperlinks are provided in section 2404 that may link to map information, for example. The map information may be provided in a “pop-up” window, for example. Online services such as GOOGLE MAPS™ can be used to gather the necessary map information.

In some example embodiments, an apparatus such as any of the apparatuses 300, 400, 500 and 800 described with respect to FIGS. 3, 4, 5, and 8, may browse the name of the meeting participants, collect information about the participants from a networking database or the like such as LINKEDIN™, FACEBOOK™ etc. and present this information to the user. It is also possible to collect information about the participant's companies, jobs, field of expertise etc.

In some example embodiments, the briefing may be sent and/or displayed at a specified time. For example, at 7 PM of each day, a briefing may be sent summarizing the schedule of the next day. The briefing may be configurable by the user, whereby the user may choose the type of information to be displayed, the manner in which the information should be displayed, and the time when the briefing should be sent. This feature may be user enabled feature whereby the user may choose to use the feature or not.

The user may use specific colors, logos, images, backgrounds etc. in the briefing to customize it. In some example embodiments, the colors, logos, images, backgrounds etc. should be hosted on a server, and may be provided for a fee. Furthermore, it is possible to track the links clicked in the briefing in order to obtain a fee in return for, for example, using a pay-per-click type of systems.

Intelligence Engine

In some example embodiments, an apparatus such as any of the apparatuses 300, 400, 500 and 800 described with respect to FIGS. 3, 4, 5, and 8, further includes an intelligence module. The intelligence module may be part of and/or communicate with the statistics data generator. The intelligence module may receive context data associated with one or more data items contained in the classified calendar data. The context data may provide additional information concerning or relating to the classified calendar data item. For example, if the user is on a business trip, the intelligence module may be used to recommend services relating either to the location of the business trip or with one or more participants in meetings that will occur during the trip. The recommended services may include car rental, hotels, restaurants etc. In some example embodiments, the intelligence module may use data from other users' schedules and calendar data (without displaying any confidential information or identification of the users), in order to obtain the context data. In some example embodiments, the intelligence module may receive information (such as information regarding locations, business, car rentals, hotel, restaurants etc.) from the internet or other sources. Thus, the intelligence module may help the user better organize their time, and obtain services.

The intelligence module may recommend people to invite to a meeting as a user is putting together the meeting invitation. Once the user has entered a particular person as a meeting participant, the intelligence module may generate statistics data about that participant and recommend other people. For example, a person could be recommended because the statistics data shows that the user usually meets with that person as the same time as the user meets with the participant that was entered in the meeting invitation. Similar, the intelligence module may recommend locations. For example, a location may be recommended because the statistics data indicates that the user typically meets that participant that was entered in the meeting invitation at that specific location.

Meeting Buffers

In another aspect, it is possible to use location information to create buffers between meetings whereby, if the estimated travel time between the location of an already scheduled meeting and a requested meeting overlap with the start time of the requested meeting, a buffer of time is created which is equal to or greater than the estimated travel time between the two locations.

In some example embodiments, location information from a database, such as GOOGLE MAPS™, may be used in order to estimate a travel time between the location of the meeting that is already booked and the location of the requested meeting. For example, if the user has a meeting that is already scheduled and booked at location A, which ends at 1 PM, and another user requests a meeting at a location B that starts at 1:15 PM, an estimate of travel time between locations A and B may be obtained. For example, such an estimate may be obtained over the Internet, or generated at a server or client device based on location information. If the estimated travel time is 30 minutes, then it may not be permitted to schedule the meeting before 1:30 PM unless the other user changes the location, in which case, the same process described above will be repeated with a new location. This process may be performed by a server or a client device, for example.

Ability to Compare with Aggregate Data

In some example embodiments, the calendar data of multiple individual users may be received, for example, by the server or the client device. The statistics data generator may run a set of statistic analyses of the data of each specific user. In an example embodiment, the server stores the calendar of each different user, and the statistics data generator runs statistical analysis for the aggregate information of all calendar entries of all users in the system. Such example embodiments may allow statistics data concerning general trends of user behavior to be generated. Then, each individual user may be able to compare their own specific trends with that of the aggregate of the users on the system.

In some example embodiments, the statistics data generator runs aggregate statistical analysis on a subset of users' classified calendar data. The subset of users may have similar characteristics, such as similar titles, companies, industry, etc. Each individual user may be able to compare their results with the aggregate.

As an example, looking at the meetings/day graph. A user will be able to compare his chart with that of the “average” user of the system. Or, they may compare it with the graph of every user that has a CEO title, or anyone that works at a specific place/company. This can also be applied to any other charts.

Productivity Suggestions Based On Aggregate Data

Given the ability to compare with aggregate data as discussed above, in some example embodiments, recommendations for a particular user are made on the basis of the statistics of an average user in the same domain as the particular user. For example, the system may state to the user “You are scheduling 30% less external meetings than the average sales person in your industry. Therefore, we recommend that you try scheduling one additional meeting every day.” In another example, the system may state to the user: On average, each meeting lasts 75 minutes. We recommend that you try to bring this down to 60 minutes—which is the standard for people with your title in your industry.

Recommendations Based on Different Calendar Entries

In some further example embodiments, when a user makes a specific entry in his calendar, recommendations of different services may be made. For example, if the user enters an entry for a meeting in San Francisco, the system may then make a recommendation for flights, hotels, restaurants, etc. These recommendations may also follow certain corporate restrictions imposed by the corporation. For example, if the employer of the user can only allow travel with United Airlines, the system would only propose flights with that airline etc.

Another example, based on the different calendar entries, is if the system knows that the user often stops by STARBUCKS™ in the morning, and finds that the user has a meeting at or near a STARBUCKS™ location in the morning, the system may make a recommendation that you pass by the STARBUCKS™ location after the meeting. The system may also provide directions to that location.

The methods described herein are provided as example embodiments. Other example embodiments may include some, but not all, of the steps described herein with respect to the example embodiments. Furthermore, the steps of methods according to some example embodiments may be performed in a different order than shown in FIGS. 2 and 7 and described herein.

Example Mobile Device

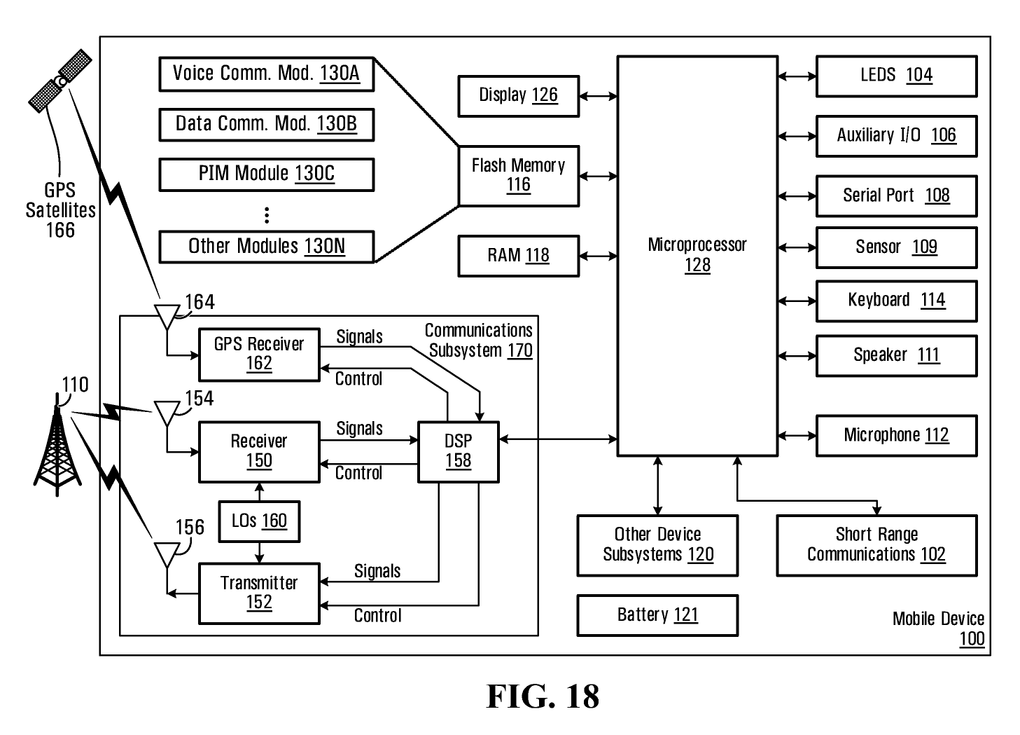

FIG. 18 shows block diagram a mobile device that may implement the methods described herein. The mobile device 100 is shown with specific components for implementing features similar to those of the apparatuses 400, 500 shown in FIGS. 4 and 5 respectively. It is to be understood that the mobile device 100 is shown with very specific details for exemplary purposes only.

The mobile device 100 has a housing that may be elongated vertically, or may take on other sizes and shapes (including clamshell housing structures). The keyboard 114 may include a mode selection key, or other hardware or software for switching between text entry and telephony entry. Alternatively, the mobile device 100 may have a housing that does not take on other sizes and shapes.

A microprocessor 128 is shown schematically as coupled between a keyboard 114 and a display 126. The microprocessor 128 is a type of processor with features similar to those of the processor 406 and 506 of the apparatuses shown in FIGS. 4 and 5 respectively. The microprocessor 128 controls operation of the display 126, as well as overall operation of the mobile device 100, in response to actuation of keys on the keyboard 114 by a user.

In addition to the microprocessor 128, other parts of the mobile device 100 are shown schematically. These include: a communications subsystem 170; a short-range communications subsystem 102; the keyboard 114 and the display 126, along with other input/output devices including a set of LEDs 104, a set of auxiliary I/O devices 106, a serial port 108, a speaker 111 and a microphone 112; as well as memory devices including a flash memory 116 and a Random Access Memory (RAM) 118; and various other device subsystems 120. The mobile device 100 may have a battery 121 to power the active elements of the mobile device 100. The mobile device 100 is in some example embodiments a two-way radio frequency (RF) communication device having voice and data communication capabilities. In addition, the mobile device 100 in some example embodiments has the capability to communicate with other computer systems via the Internet.

Operating system software executed by the microprocessor 128 is in some example embodiments stored in a persistent store, such as the flash memory 116, but may be stored in other types of memory devices, such as a read only memory (ROM) or similar storage element. In addition, system software, specific device applications, or parts thereof, may be temporarily loaded into a volatile store, such as the RAM 118. Communication signals received by the mobile device 100 may also be stored to the RAM 118.

The microprocessor 128, in addition to its operating system functions, enables execution of software applications on the mobile device 100. A predetermined set of software applications that control basic device operations, such as a voice communications module 130A and a data communications module 130B, may be installed on the mobile device 100 during manufacture. In addition, a personal information manager (PIM) application module 130C may also be installed on the mobile device 100 during manufacture. The PIM application is in some example embodiments capable of organizing and managing data items, such as e-mail, calendar events, voice mails, appointments, and task items. The PIM application is also in some example embodiments capable of sending and receiving data items via a wireless network 110. In some example embodiments, the data items managed by the PIM application are seamlessly integrated, synchronized and updated via the wireless network 110 with the device user's corresponding data items stored or associated with a host computer system.

Additional software modules, illustrated as another software module 130N, may be installed during manufacture. The software modules can include, for example, the statistics data generator 502 of the apparatus 500 shown in FIG. 5. Note that the implementations described with reference to FIG. 18 are very specific for exemplary purposes. For example, alternative implementations are possible in which the information updater is not implemented as software and stored on the flash memory 116. More generally, the information updater may be implemented as software, hardware, firmware, or any appropriate combination thereof.

Communication functions, including data and voice communications, are performed through the communications subsystem 170, and possibly through the short-range communications subsystem 102. The communications subsystem 170 includes a receiver 150, a transmitter 152, a GPS receiver 162, and one or more antennas, illustrated as a receive antenna 154, a transmit antenna 156, and a GPS antenna 164. In addition, the communication subsystem 170 also includes a processing module, such as a digital signal processor (DSP) 158, and local oscillators (LOs) 160. The receiver 150 may be similar to the receiver 406 of FIG. 4.

The specific design and implementation of the communications subsystem 170 is dependent upon the communication network in which the mobile device 100 is intended to operate. For example, the communications subsystem 170 of the mobile device 100 may be designed to operate with the Mobitex™, DataTAC™ or General Packet Radio Service (GPRS) mobile data communication networks and also designed to operate with any of a variety of voice communication networks, such as Advanced Mobile Phone Service (AMPS), Time Division Multiple Access (TDMA), Code Division Multiple Access (CDMA), Personal Communications Service (PCS), Global System for Mobile Communications (GSM), etc. Examples of CDMA include 1X and 1x EV-DO. The communication subsystem 170 may also be designed to operate with an 802.11 Wi-Fi network, or an 802.16 WiMAX network or both. Other types of data and voice networks, both separate and integrated, may also be utilized with the mobile device 100.

Network access may vary depending upon the type of communication system. For example, in the Mobitex™ and DataTAC™ networks, mobile devices are registered on the network using a unique Personal Identification Number (PIN) associated with each device. In GPRS networks, however, network access is typically associated with a subscriber or user of a device. A GPRS device therefore typically has a subscriber identity module, commonly referred to as a Subscriber Identity Module (SIM) card, in order to operate on a GPRS network.

When network registration or activation procedures have been completed, the mobile device 100 may send and receive communication signals over the communication network 110. Signals received from the communication network 110 by the receive antenna 154 are routed to the receiver 150, which provides for signal amplification, frequency down conversion, filtering, channel selection, etc., and may also provide analog to digital conversion. Analog-to-digital conversion of the received signal allows the DSP 158 to perform more complex communication functions, such as demodulation and decoding. In a similar manner, signals to be transmitted to the network 110 are processed (e.g., modulated and encoded) by the DSP 158 and are then provided to the transmitter 152 for digital to analog conversion, frequency up conversion, filtering, amplification and transmission to the communication network 110 (or networks) via the transmit antenna 156.

In addition to processing communication signals, the DSP 158 provides for control of the receiver 150, the transmitter 152, and the GPS receiver 162. For example, gains applied to communication signals in the receiver 150 and the transmitter 152 may be adaptively controlled through automatic gain control algorithms implemented in the DSP 158.

In a data communication mode, a received signal, such as a text message or web page download, is processed by the communication subsystem 170 and is input to the microprocessor 128. The received signal is then further processed by the microprocessor 128 for an output to the display 126, or alternatively to some other auxiliary I/O devices 106. A device user may also compose data items, such as e-mail messages, using at least one of the keyboard 114 and some other auxiliary I/O device 106, such as a touchpad, a rocker switch, a thumb-wheel, or some other type of input device. The composed data items may then be transmitted over the communication network 110 via the communication subsystem 170.

In a voice communication mode, overall operation of the device is substantially similar to the data communication mode, except that received signals are output to a speaker 111, and signals for transmission are generated by a microphone 112. Alternative voice or audio I/O subsystems, such as a voice message recording subsystem, may also be implemented on the mobile device 100. In addition, the display 126 may also be utilized in voice communication mode, for example, to display the identity of a calling party, the duration of a voice call, or other voice call related information.

Location determination using GPS technology involves receiving GPS signals from GPS satellites 166 on the antenna 164. The GPS signals are received using the GPS receiver 162 and processed by the DSP 158. Typically, GPS signals from at least four satellites are processed. Further details of GPS are omitted for simplicity.

The short-range communications subsystem 102 enables communication between the mobile device 100 and other proximate systems or devices, which need not necessarily be similar devices. For example, the short range communications subsystem may include an infrared device and associated circuits and components, or a Bluetooth™ communication module to provide for communication with similarly-enabled systems and devices.

Other

According to some aspects, a computer-readable medium is provided having computer-executable instructions stored thereon that, when executed, cause a computer to implement any one of the methods described herein.

While some specific example embodiments have been described above and illustrated in the accompanying drawings, it will be evident to those skilled in the art that modifications may be made without departing from this disclosure. Such modifications are considered as possible variants included in the scope of the disclosure.

1. An apparatus comprising:
a processor configured to:
generate statistics data as a function of classified calendar data, the classified calendar data comprising, for each of a plurality of calendar events, a respective plurality of data items that are collectively organized according to a plurality of event data categories; and
transmit at least a portion of the statistics data.

2. The apparatus of claim 1, wherein the classified calendar data is stored in a first matrix in a database.

3. The apparatus of claim 2, wherein the first matrix comprises a row for each of the plurality of calendar events and a column for each of the plurality of event data categories such that each of the data items of the classified calendar data corresponds to a respective field of the first matrix.

4. The apparatus of claim 1, wherein the plurality of data categories comprises at least one of: meeting type data; participant data; date data; duration data; and location data.

5. The apparatus of claim 1, further comprising the processor is further configured to receive calendar data for at least one of the plurality of calendar events.

6. The apparatus of claim 5, wherein the processor is further configured to transmit a request for the calendar data for the at least one of the plurality of calendar events.

7. The apparatus of claim 5, further comprising the processor is further configured to classify the calendar data, thus received, to generate at least a portion of the classified calendar data.

8. The apparatus of claim 1, further comprising the processor is further configured to receive at least a portion of the classified calendar data.

9. The apparatus of claim 1, wherein generating the statistics data as a function of the classified calendar data comprises correlating data items for at least one of the plurality of calendar events and data items corresponding to at least one of the plurality of event data categories.

10. The apparatus of claim 1, wherein generating statistics data as a function of classified calendar data comprises generating statistics data as a function of data items of two or more of the plurality of data categories.

11. The apparatus of claim 1, wherein generating statistics data as a function of the classified calendar data comprises generating statistics data as a function of the classified calendar data and at least one analysis criterion.

12. The apparatus of claim 11, wherein the at least one analysis criterion comprises at least one common denominator.

13. The apparatus of claim 12, wherein the plurality of event data categories comprises at least one of: meeting type data; participant data; date data; duration data; and location data, and wherein
the at least one common denominator comprises at least one of: a meeting type; a participant; a date; a duration; and a location.

14. The apparatus of claim 12, wherein:
the classified calendar data is stored in a first matrix in a database; and
generating statistics data as a function of the classified calendar data and at least one analysis criterion comprises: generating a respective additional matrix containing classified data for each of the plurality of calendar events including the at least one common denominator in the respective plurality of data items of that calendar event.

15. The apparatus of claim 11, further comprising the processor is further configured to receive the at least analysis criterion.

16. The apparatus of claim 1, wherein transmitting the at least a portion of the statistics data comprises transmitting a message for reception by a client device, the message containing the at least a portion of the statistics data.

17. The apparatus of claim 1, further comprising the processor is further configured to, for each of at least one of the plurality of calendar events, receive a respective event tag and storing the event tag as one of the respective plurality of data items of the calendar event.

18. The apparatus of claim 1, further comprising the processor is further configured to generate at least one data item of the respective plurality of data items for at least one calendar event.

19. The apparatus of claim 1, further comprising the processor is further configured to receive for at least one of the plurality of calendar events, context data associated with one or more of the plurality of data items.

20. A server comprising:
a processor configured to retrieve calendar data from a calendar and classify data associated with each calendar event;
a database configured to store the classified calendar data as a matrix;
the processor configured to:
process the classified calendar data and generate correlation information between different rows and columns of different calendar events;
receive a selection of at least one search category; and
generate and present personalized views of the calendar data, based on the selection.

21. The server of claim 20, further comprising the processor is further configured to receive a selection of a time range for the calendar data to be presented.

22. The server of claim 20, further comprising the processor is further configured to:
assign a tag to at least one calendar event in the calendar; and
add the tag to a list of search categories.

23. The server of claim 22, further comprising the processor is further configured to assign more than one tag to at least one calendar event in the calendar.

24. The server of claim 22, further comprising the processor is further configured to grant access to calendar events having a certain tag.

25. The server of claim 20, wherein generating correlation information includes creating at least one virtual matrix based on a common denominator of the data included in the first matrix.
